(19) United States
(12) Patent Application Publication
(10) Pub. No.: US 2015/0024358 A1
(43) Pub. Date: Jan. 22, 2015

(54) STRESS ASSESSMENT DEVICE, STRESS ASSESSMENT METHOD AND RECORDING MEDIUM

(71) Applicants: Yuki Kamiya, Tokyo (JP); Kazuo Kunieda, Tokyo (JP); Shogo Okada, Tokyo (JP); Katsumi Nitta, Tokyo (JP); Yusaku Sato, Tokyo (JP)

(72) Inventors: Yuki Kamiya, Tokyo (JP); Kazuo Kunieda, Tokyo (JP); Shogo Okada, Tokyo (JP); Katsumi Nitta, Tokyo (JP); Yusaku Sato, Tokyo (JP)

(73) Assignees: Tokyo Institute of Technology, Tokyo (JP); NEC Corporation, Tokyo (JP)

(21) Appl. No.: 14/383,525

(22) PCT Filed: Feb. 7, 2013
(86) PCT No.: PCT/JP2013/053596

§ 371 Date: Sep. 5, 2014

(30) Foreign Application Priority Data
Mar. 5, 2012 (JP) 2012-047769

(51) Int. Cl. G09B 19/00

(52) U.S. Cl. CPC G09B 19/00
USPC 434/236

(57) ABSTRACT

It is an object of this invention to provide a stress assessment device capable of assessing mental stress without requiring another previous knowledge or imposing a load on an observer or an employee. A stress assessment device (10) of this invention includes: a work behavior acquisition unit (101) for acquiring a work behavior time-series pattern serving as information indicating a work behavior of each employee in temporal units; an eigen-behavior time-series pattern calculation unit (102) for calculating an eigen-behavior time-series pattern serving as information indicating a standard work behavior of each employee by using the work behavior time-series pattern; and a stress state assessment unit (103) for calculating a reconstruction accuracy indicating a degree to which the work behavior time-series pattern of each employee and the eigen-behavior time-series pattern agree with each other and assessing a stress state of the employee based on the calculated reconstruction accuracy.

### TECHNICAL FIELD

This invention relates to a stress assessment device, a stress assessment method, and a program therefor.

### BACKGROUND ART

It is important for a company to grasp mental burdens on its employees in terms of management of productivity of the company.

Therefore, various methods for grasping stress states of the employees are under study.

For example, Patent Document 1 discloses a management method and a management system for an employee behavior which are capable of discovering and treating a mental health condition at an early stage based on a behavior characteristic unique to each individual (Patent Document 1).

On the other hand, Non Patent Document 1 discloses a method of estimating stress based on accuracy in keyboard inputting or a linguistic feature of an input sentence (Non Patent Document 1).

### PRIOR ART DOCUMENTS

### Patent Document

Patent Document 1: JP-A-2011-123579

### Non Patent Document

Non Patent Document 1: Lisa M. Vizer, et. al.: “Automated stress detection using keystroke and linguistic features: An exploratory study”, Intl. Journal of Human-Computer Studies, Vol. 67, 10, 2009. (2009)

### DISCLOSURE OF THE INVENTION

### Problems to be Solved by the Invention

However, the above-mentioned technology necessitates some previous knowledge in assessment of stress of an employee. Therefore, a heavy burden is imposed on a designer who suitably sets an assessment method.

For example, in the technology disclosed in Patent Document 1, it is used as an assessment criterion whether or not the behavior of the employee falls within a range of behavior characteristic data based on a behavior history of an individual.

In this case, alienation from the behavior history inside an office is used as a criterion for presence/absence of the stress, and it is necessary to define a suitable criterion in consideration of actual work, for example, what kind of behavior is to be observed or what extent of alienation is used as the assessment criterion. In general, it is extremely difficult to define such a criterion.

On the other hand, in the technology disclosed in Non Patent Document 1, in order to estimate the stress, it is necessary to examine in advance relationships between the stress and different kinds of features of keystrokes. As a specific example, it is necessary to employ a procedure for causing the employee to execute a simulation task designed for a stress state and a controlled state and selecting one that is effective for estimating the stress state from values of different kinds of features of keystrokes obtained in the two states.

This invention has been made in view of the above-mentioned problems, and provides a stress assessment device capable of assessing mental stress without requiring another previous knowledge or imposing a load on an observer or an employee.

### Means to Solve the Problems

In order to solve the above-mentioned problems, according to a first aspect of this invention, there is provided a stress assessment device, including: a work behavior acquisition unit for acquiring a work behavior time-series pattern serving as information indicating a work behavior of each employee in temporal units; an eigen-behavior time-series pattern calculation unit for calculating an eigen-behavior time-series pattern serving as information indicating standard work behaviors of a plurality of employees by using the work behavior time-series patterns; and a stress state assessment unit for calculating a value indicating a degree to which the work behavior time-series pattern of each employee and the eigen-behavior time-series pattern agree with each other, setting the value as reconstruction accuracy, and assessing a stress state of the employee based on the calculated reconstruction accuracy.

According to a second aspect of this invention, there is provided a stress assessment method, including: (a) acquiring a work behavior time-series pattern serving as information indicating a work behavior of each employee in temporal units; (b) calculating an eigen-behavior time-series pattern serving as information indicating standard work behaviors of a plurality of employees by using the work behavior time-series patterns; and (c) calculating a degree to which the work behavior time-series behavior pattern of each employee with respect to the eigen-behavior time-series pattern and the eigen-behavior time-series pattern agree with each other, setting the degree as reconstruction accuracy, and assessing a stress state of the employee based on the reconstruction accuracy.

According to a third aspect of this invention, there is provided a program for causing a computer to operate as the stress assessment device according to the first aspect.

### Effect of the Invention

According to one embodiment of this invention, it is possible to provide the stress assessment device capable of assessing mental stress without requiring another previous knowledge or imposing a load on an observer or an employee.

### BRIEF DESCRIPTION OF THE DRAWING

FIG. 1 is a block diagram illustrating a configuration of the best mode for carrying out this invention.

FIG. 2 is a flowchart illustrating an outline of an overall operation according to an embodiment of this invention.

FIG. 3 is a flowchart illustrating the overall operation according to the embodiment of this invention.

FIG. 4 is a flowchart illustrating an operation for assessing a stress degree according to the embodiment of this invention.

FIG. 5 is a block diagram illustrating components according to Example of this invention.

FIG. 6 is a specific example of a work behavior time-series pattern acquired in Example.

FIG. 7 is a specific example of an eigen-behavior time-series pattern calculated in Example.

FIG. 8 is a specific example of a time-series pattern of a continuous value obtained after projection, which is calculated in Example.

FIG. 9 is a specific example of a reconstruction time-series pattern calculated in Example.

FIG. 10 is a specific example of average reconstruction accuracy calculated in Example.

FIG. 11 is a specific example of the stress degree assessed in Example.

FIG. 12 is an example of the work behavior time-series pattern obtained in an evaluation experiment according to Example.

FIG. 13 is an example of the eigen-behavior time-series pattern obtained in the evaluation experiment according to Example.

FIG. 14 is a graph of a maximum value, a minimum value, and an average value of reconstruction accuracy obtained in the evaluation experiment according to Example.

FIG. 15 is a table of a value of the reconstruction accuracy of each employee obtained in a case of using up to a ninth principal component pattern in the evaluation experiment according to Example.

FIG. 16 is a table of an average stress value of each employee obtained in the evaluation experiment according to Example.

FIG. 17 is a table of a change in a correlation between the average reconstruction accuracy and the average stress value due to a difference in the number of eigen-behavior time-series patterns in the evaluation experiment according to Example.

### MODE FOR EMBODYING THE INVENTION:

Now, an exemplary embodiment of this invention is described in detail with reference to the accompanying drawings.

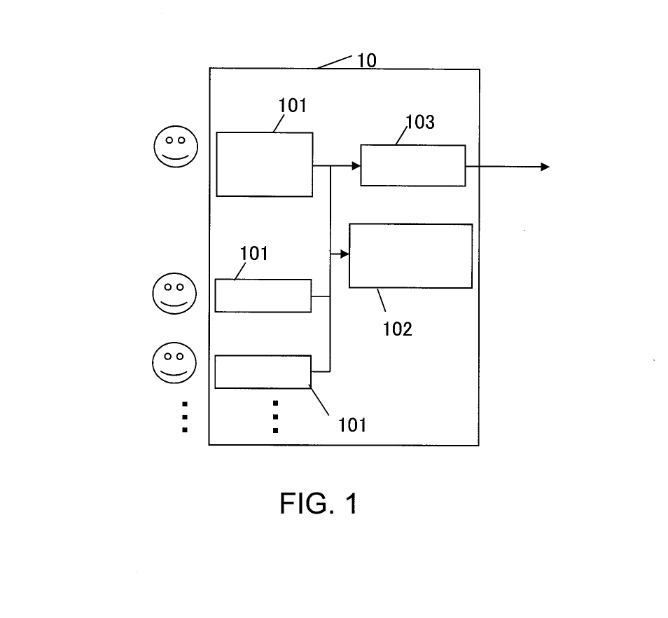

First, a schematic structure of a stress assessment device 10 according to a first embodiment of this invention is described with reference to FIG. 1.

As illustrated in FIG. 1, the stress assessment device 10 includes a work behavior acquisition unit 101 for acquiring a work behavior time-series pattern indicating work information such as a PC operation of an employee and presence/absence of conference holding, an eigen-behavior time-series pattern calculation unit 102 for calculating an eigen-behavior time-series pattern indicating standard work behaviors of a plurality of employees at an office by using the accumulated work behavior time-series patterns, and a stress state assessment unit 103 for assessing a stress state based on reconstruction accuracy of the work behavior time-series pattern of each employee relative to the eigen-behavior time-series pattern calculated by the eigen-behavior time-series pattern calculation unit 102.

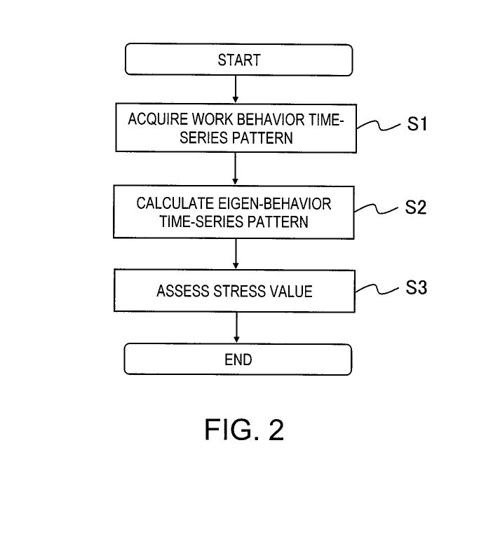

Next, an outline of an operation of the stress assessment device 10 performed to assess the stress is described with reference to FIG. 2.

First, the work behavior acquisition unit 101 acquires the work behavior time-series pattern of the employee (S1 of FIG. 2).

Subsequently, the eigen-behavior time-series pattern calculation unit 102 uses the accumulated work behavior time-series patterns to calculate the eigen-behavior time-series pattern (S2 of FIG. 2).

Finally, the stress state assessment unit 103 calculates the reconstruction accuracy of the work behavior time-series pattern of each employee relative to the eigen-behavior time-series pattern, and assesses the stress state of each employee based on the value (S3 of FIG. 2).

Here, the work behavior time-series pattern of the employee acquired by the work behavior acquisition unit 101 represents a data sequence indicating a time-series change in the state of a work event that can be automatically acquired by a sensor or the like. Specific examples thereof include a change pattern of a daily PC operation, conference holding, or the like, but this invention is not limited thereto.

Further, a timing at which the eigen-behavior time-series pattern calculation unit 102 calculates the eigen-behavior time-series pattern may be a timing at which the number of accumulated patterns reaches a fixed number defined in advance, or may be calculated every time.

Next, an operation example of the first embodiment is described in more detail.

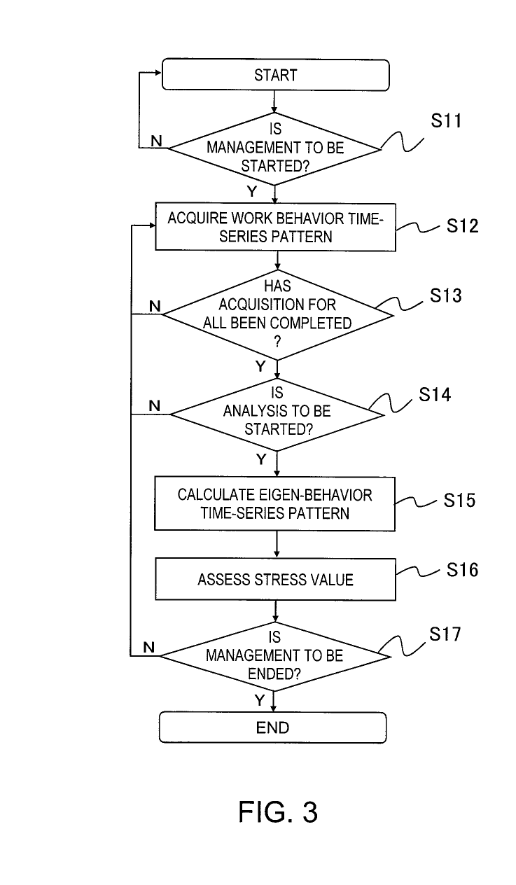

FIG. 3 is a flowchart illustrating an overall operation performed in the operation example of the first embodiment.

First, any one of the work behavior acquisition unit 101, the eigen-behavior time-series pattern calculation unit 102, and the stress state assessment unit 103 of the stress assessment device 10 determines whether or not the device is to start management based on whether or not an instruction is received from outside (S11 of FIG. 3), and when the management is to be started, the procedure advances to the next step.

When the management is to be started, the work behavior acquisition unit 101 of the stress assessment device 10 acquires the work behavior time-series pattern indicating a daily change in a work behavior from each employee (S12 of FIG. 3). After that, the work behavior acquisition unit 101 determines whether or not acquisition of data on all the employees to be managed has been completed (S13 of FIG. 3), and when the acquisition has been completed, the procedure advances to the next step.

Subsequently, the eigen-behavior time-series pattern calculation unit 102 of the stress assessment device 10 determines whether or not to start an analysis (whether or not to calculate the eigen-behavior time-series pattern) based on a timing at which a condition designated in advance is satisfied or the like (S14 of FIG. 3), and when the condition is satisfied, calculates the eigen-behavior time-series pattern from the accumulated work behavior time-series patterns (S15 of FIG. 3).

After that, the stress state assessment unit 103 of the stress assessment device 10 uses the calculated eigen-behavior time-series pattern to assess a stress value of each employee based on the reconstruction accuracy of the work behavior time-series pattern of each employee (S16 of FIG. 3).

Finally, any one of the work behavior acquisition unit 101, the eigen-behavior time-series pattern calculation unit 102, and the stress state assessment unit 103 determines whether or not the device is to end the management based on whether or not an instruction is received from outside (S17 of FIG. 3). When the management is to be ended, the processing is brought to an end, and when the management is not to be ended, the procedure returns to S12.

Here, the operation of the stress assessment device 10 performed in stress assessment processing is described in more detail.

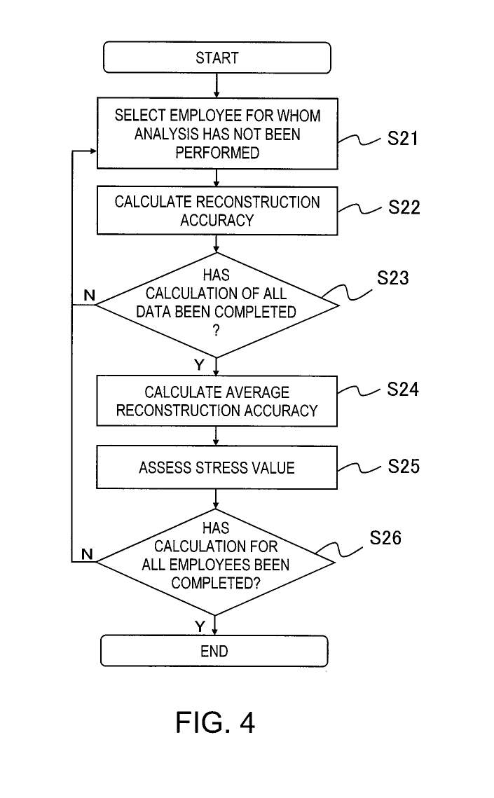

FIG. 4 is a flowchart illustrating an operation for performing the stress assessment processing in the operation example of the first embodiment.

As illustrated in FIG. 4, in the stress assessment processing, first, the stress state assessment unit 103 selects an employee for whom the analysis has not been performed (S21 of FIG. 4), and calculates the reconstruction accuracy of the work behavior time-series pattern of the selected employee relative to the calculated eigen-behavior time-series pattern (S22 of FIG. 4). When the calculation of the reconstruction accuracy of the work behavior time-series patterns of all such employees is finished (S23 of FIG. 4), an average reconstruction accuracy for the employees is calculated (S24 of FIG. 4). Subsequently, the stress assessment processing is executed for the employee based on the calculated average reconstruction accuracy (S25 of FIG. 4). The above-mentioned processing is executed for all the employees (S26 of FIG. 4).

Note that, the stress assessment processing may be performed after the average reconstruction accuracy for all the employees is calculated, or may be performed immediately after the average reconstruction accuracy for each employee is calculated.

Further, as a method for the stress assessment processing, in accordance with the value of the reconstruction accuracy, the assessment may be performed by using several steps of high, normal, and low, may be expressed by an actual numerical value, or may be expressed by percentage.

### EXAMPLE

Next, a description is made of an operation of the best mode for carrying out this invention with reference to specific Example. Example is described by taking an example in which the number of employees is three.

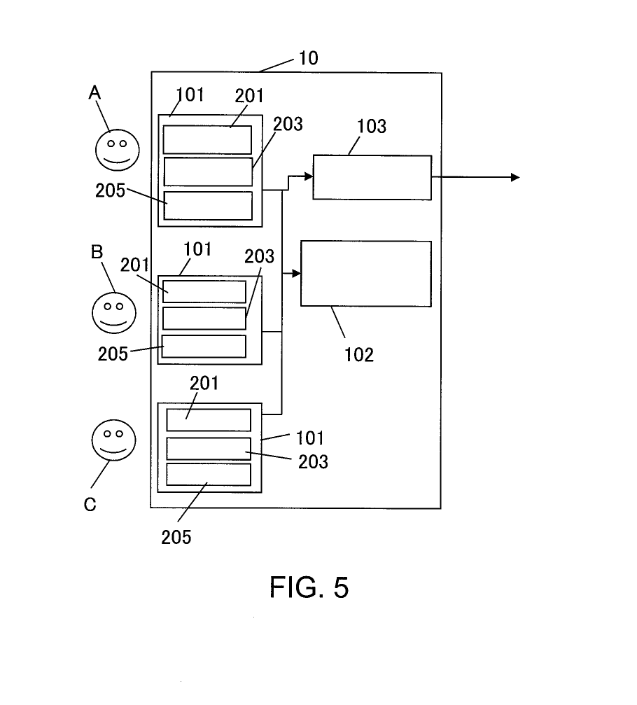

The configuration of Example is as illustrated in FIG. 5.

In FIG. 5, the employees are denoted by “A”, “B”, and “C”, and the work behavior acquisition means 101 is provided to each employee. Further, in FIG. 5 and the following embodiment, as data obtained by the work behavior acquisition unit 101, with a predetermined time unit set as a minute of a day, three kinds of information: PC operation information 201 indicating the presence/absence of the PC operation in units of minutes of a day; conference holding information 203 indicating the presence/absence of a meeting; and other information 205 indicating the presence/absence of an in-office activity other than the PC and the meeting are taken as an example, but this invention is not limited thereto.

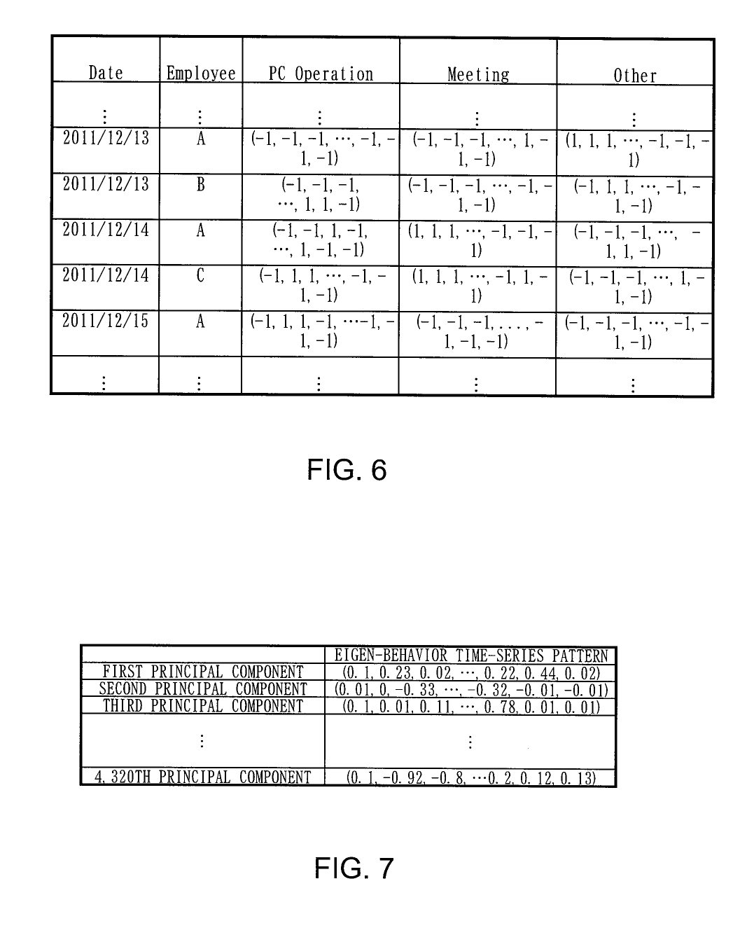

FIG. 6 shows a specific example of the data obtained by the work behavior acquisition unit 101.

In the example shown here, the PC operation information 201 (referred to as “PC Operation” in FIG. 6), the conference holding information 203 (referred to as “Meeting” in FIG. 6), and the other information 205 (referred to as “Other” in FIG. 6) are expressed by binarization processing, and three kinds of data having 1,440 dimensions arrayed in time series are set as the work behavior time-series pattern. Note that, the three kinds of time-series pattern are combined for an analysis and handled as a vector having 4,320 dimensions in total.

Under the above-mentioned setting conditions, at a timing set in advance, the eigen-behavior time-series pattern calculation unit 102 analyzes the accumulated work behavior time-series patterns, and calculates the eigen-behavior time-series patterns for all the employees.

The timing set in advance is, for example, an interval of one month, and the analysis is performed by using all patterns accumulated every month so far.

In the calculation of the eigen-behavior time-series pattern, principal component analysis processing is performed by using a work behavior time-series pattern group for all the employees as an input.

FIG. 7 shows an example of the calculated eigen-behavior time-series pattern.

The eigen-behavior time-series patterns are handled in order from one that has the largest eigenvalue as a first principal component pattern. The 4,320 eigen-behavior time-series patterns are obtained in total.

After that, the stress state assessment unit 103 uses the eigen-behavior time-series pattern to calculate the reconstruction accuracy of each of the work behavior time-series patterns.

The reconstruction accuracy is calculated for each employee by the following procedure.

First, the stress state assessment unit 103 performs projection for each work behavior time-series pattern of the employee with respect to a space defined by a principal component pattern. Specifically, the following expression is used.

[Math. 1]

C=XAₖAₖ^{T} (1)

In the expression, C represents a behavior time-series pattern matrix after the projection, and is

$$C = ( \begin{matrix}{c}_{1} \\ {c}_{2} \\ ⋮ \\ {c}_{m}\end{matrix} )$$

expressed by the following matrix.

$$X = ( \begin{matrix}{x}_{1} \\ {x}_{2} \\ ⋮ \\ {x}_{m}\end{matrix} )$$

Further, X represents a work behavior time-series pattern matrix, and is expressed by the following matrix.

Xᵢ=[xᵢ₁,xᵢ₂, . . . , xᵢₙ]

( . . . (n represents the number of dimensions; in this embodiment, n=4,320) represents a daily work behavior time-series pattern)
Aₖ represents a principal component pattern matrix (k eigen-behavior time-series patterns aⱼ arrayed in descending order of the eigenvalue in column) as indicated below.

Aₖ=[a₁,a₂, . . . , aₖ]

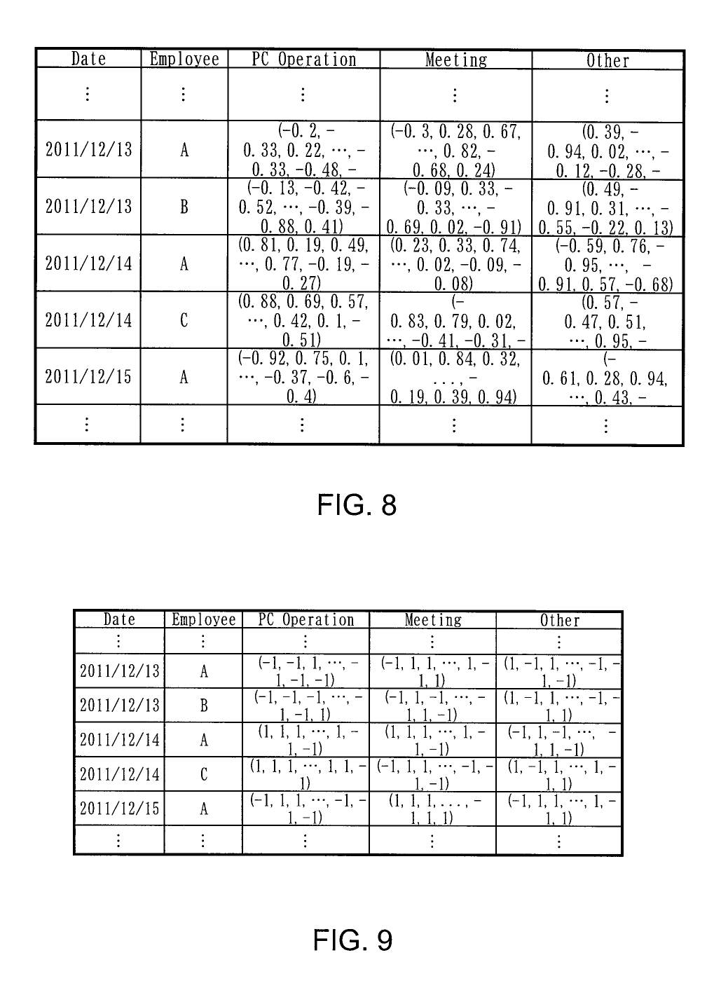

FIG. 8 shows an example of a time-series pattern of a continuous value obtained after the projection.

Subsequently, the stress state assessment unit 103 performs the binarization processing for the time-series pattern of the continuous value obtained after the projection so as to set each positive value to “1” and each negative value to “−1”, and obtains such a reconstruction time-series pattern as shown in FIG. 9.

Subsequently, the stress state assessment unit 103 compares each element between the obtained reconstruction time-series pattern and the original work behavior time-series pattern, and calculates an agreement rate thereof. That is, each element shown in FIG. 9 and FIG. 6 is compared to calculate the agreement rate.

In this case, a value obtained by averaging the agreement rate calculated for each work behavior time-series pattern is set as the reconstruction accuracy of the employee.

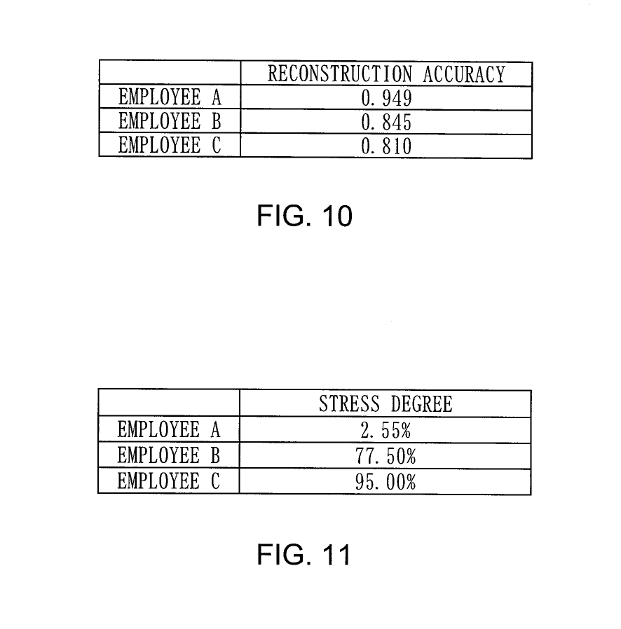

FIG. 10 shows an example of the calculated reconstruction accuracy.

It suffices that a number k of principal component patterns used to calculate the reconstruction accuracy is set so that, for example, an average value of the reconstruction accuracy of the work behavior time-series pattern of each employee exceeds 80%.

Finally, the stress state assessment unit 103 assesses a stress degree of each employee based on the calculated reconstruction accuracy.

FIG. 11 shows an example of the stress degree assessed by percentage. In this embodiment, the stress degree was defined as (1−(reconstruction accuracy)/0.8)×100.

That is, the stress state assessment unit 103 assesses that the stress state is lower as the reconstruction accuracy becomes higher when it is defined that the reconstruction accuracy is higher as the work behavior time-series pattern agrees with the eigen-behavior time-series pattern to a higher degree.

By performing the above-mentioned procedure, a manager of the employees can assess the stress degree of each employee by using the stress assessment device 10 without performing a complicated setting in advance such as a setting of a degree of a specific behavior relating to the stress or a setting of a feature amount effective for a discriminator of the stress.

Further, the stress assessment device 10 assesses the stress from an ordinary work behavior, and hence the employee is not forced to carry a special burden for stress assessment.

Subsequently, in an evaluation experiment for the stress assessment device 10, 18 employees working at the same office were subjected to a correlation analysis experiment between the reconstruction accuracy of the work behavior time-series pattern and the stress value.

Specifically, first, based on data obtained by constantly sensing the PC operation of the employee and location information within the office, the work behavior time-series pattern indicating the presence/absence of the PC operation, the meeting, and the office activity other than the PC operation or the meeting was acquired over a period from 2010 Jan. 1 to 2012 Dec. 5.

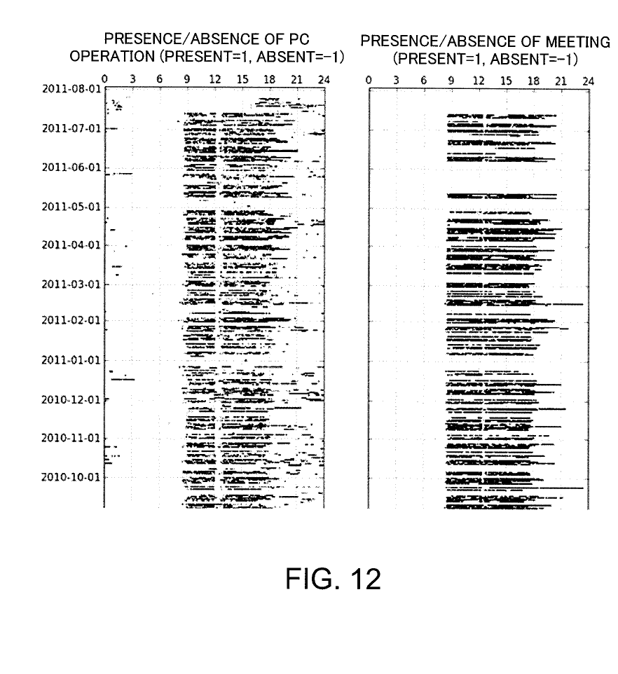

FIG. 12 shows the work behavior time-series pattern indicating the presence/absence of the PC operation from 2010 Oct. 1 to 2011 Aug. 31 with regard to the employee A for whom the acquisition was performed. The horizontal axis represents a time changing in a day, and the vertical axis represents a date.

However, a day off or a day on which data was not able to be obtained due to trouble of the sensor or the like is not used for the following analysis.

Subsequently, the work behavior time-series patterns on the days to be analyzed for all the employees were used to perform the principal component analysis processing, to thereby calculate the eigen-behavior time-series patterns for all the employees.

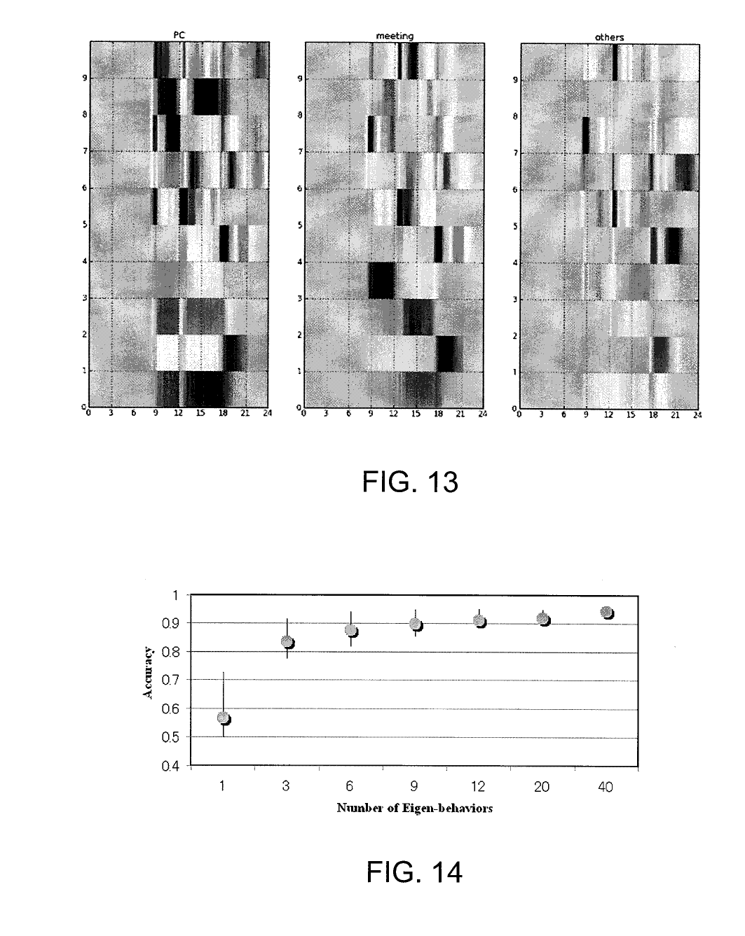

FIG. 13 shows part of the calculated eigen-behavior time-series patterns.

Further, FIG. 14 shows the reconstruction accuracy of the work behavior time-series patterns relative to the eigen-behavior time-series patterns. It is understood from the graph that the reconstruction accuracy exceeds 80% for all the employees in a case of using up to a ninth principal component.

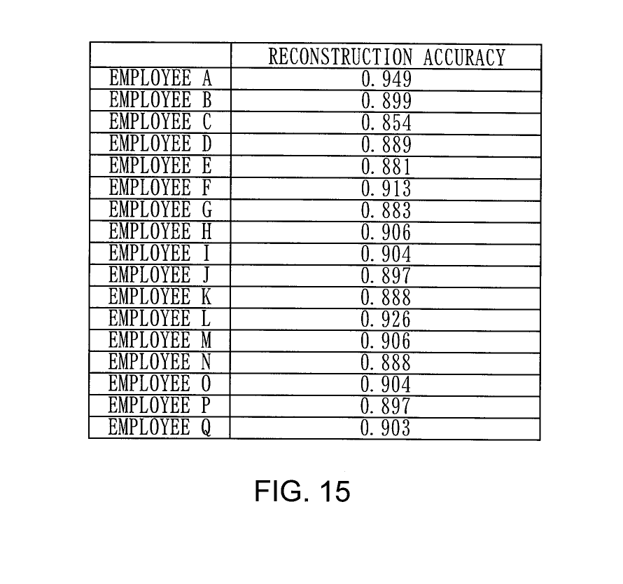

Therefore, FIG. 15 shows the value of the reconstruction accuracy for each employee when calculated by using the eigen-behavior time-series patterns up to the ninth principal component. As described above, the reconstruction accuracy for each employee was set as the average value of the reconstruction accuracy of each work behavior time-series pattern.

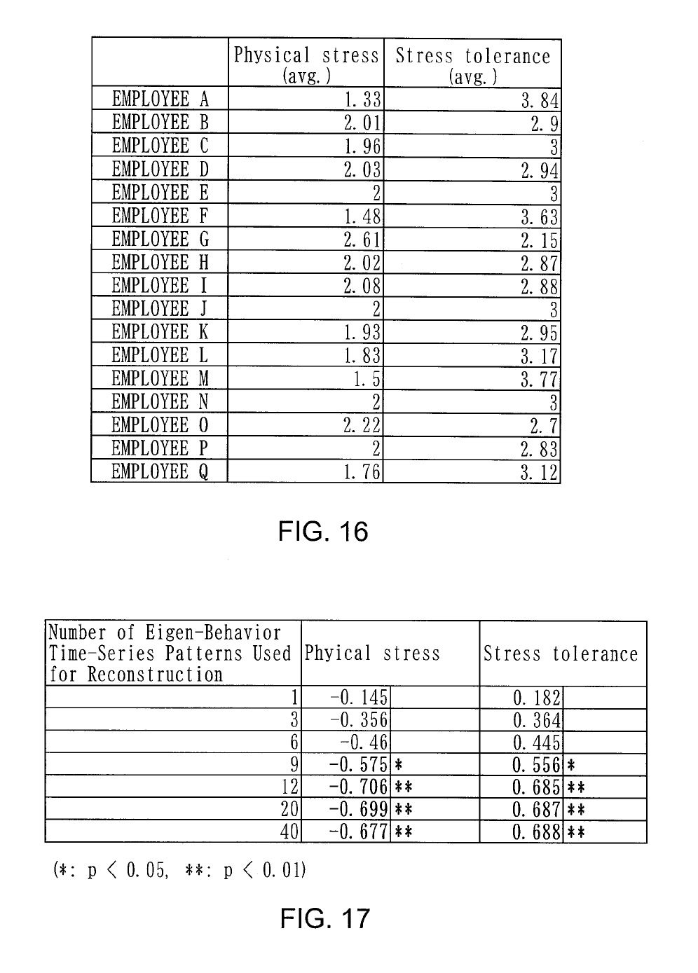

Finally, a correlation with the stress value was analyzed. The stress value was acquired over the period from 2011 July to 2011 September by using a stress checker. FIG. 16 shows average values of a physical stress value and a stress tolerance collected by the stress checker.

As a result, an intermediate significant negative correlation was observed with respect to the physical stress value, and an intermediate positive correlation was observed with respect to the stress tolerance (p<0.05).

FIG. 17 shows a change in the correlation obtained when the number k of principal components used to calculate the reconstruction accuracy was changed. It is understood from results thereof that the correlation is lower with less significance as the number of the principal components becomes smaller and that the value of the correlation does not change so greatly even as the number of the principal components becomes larger. Therefore, the number of the principal components with which the reconstruction accuracy for each employee exceeds 80% with regard to all the employees is considered as a necessary and sufficient condition indicating a significant correlation.

It has been found from the above-mentioned experimental results that, by using the stress assessment device 10, the stress of each employee can be assessed based on the reconstruction accuracy of the work behavior time-series pattern.

### INDUSTRIAL APPLICABILITY

The stress assessment device 10 according to this invention can be used as a support system for mental health care of employees.

Note that, each of the components of the stress assessment device 10 described above may be implemented by using a combination of hardware and software. In the mode that combines hardware and software, a program for causing a computer to operate as the stress assessment device 10 is expanded onto a RAM, and hardware such as a control unit (CPU) is operated based on the program, to thereby operate the respective hardware units (work behavior acquisition unit 101, eigen-behavior time-series pattern calculation unit 102, stress state assessment unit 103, and the like). Further, the program may be distributed by being recorded on a storage medium. The program recorded on the recording medium is read onto the memory through a wire, wirelessly, or via the recording medium itself, and causes the control unit and the like to operate. Note that, examples of the recording medium include an optical disc, a magnetic disk, a semiconductor memory device, and a hard disk drive.

This application claims priority from Japanese Patent Application No. 2012-047769, filed on Mar. 5, 2012, the entire disclosure of which is incorporated herein by reference.

### REFERENCE SIGNS LIST

10 stress assessment device

101 work behavior acquisition unit

102 eigen-behavior time-series pattern calculation unit

103 stress state assessment unit

1. A stress assessment device, comprising:
a work behavior acquisition unit for acquiring a work behavior time-series pattern serving as information indicating a work behavior of each employee in temporal units;
an eigen-behavior time-series pattern calculation unit for calculating an eigen-behavior time-series pattern serving as information indicating standard work behaviors of a plurality of employees by using the work behavior time-series patterns; and
a stress state assessment unit for calculating a value indicating a degree to which the work behavior time-series pattern of each employee and the eigen-behavior time-series pattern agree with each other, setting the value as reconstruction accuracy, and assessing a stress state of the employee based on the calculated reconstruction accuracy.

2. A stress assessment device according to claim 1, wherein the stress state assessment unit assesses that the stress state is lower as the reconstruction accuracy becomes higher when it is defined that the reconstruction accuracy is higher as the work behavior time-series pattern of the employee agrees with the eigen-behavior time-series pattern to a higher degree.

3. A stress assessment device according to claim 1, wherein:
the work behavior time-series pattern comprises data obtained by performing binarization processing for presence/absence of a predetermined work behavior of the each employee in temporal units to be arrayed in time series;
the eigen-behavior time-series pattern comprises data obtained by performing principal component analysis processing by using the accumulated work behavior time-series patterns as an input; and
the stress state assessment unit performs projection for the work behavior time-series pattern with respect to a space defined by a principal component pattern, performs binarization processing for positive and negative of a time-series pattern of a continuous value obtained after the projection to obtain a reconstruction time-series pattern, and compares an agreement rate between the reconstruction time-series pattern and the work behavior time-series pattern, to thereby calculate the reconstruction accuracy.

4. A stress assessment device according to claim 3, wherein the reconstruction time-series pattern comprises information obtained by performing the projection for each work behavior time-series pattern of the employee with respect to the space defined by the principal component pattern by use of the following Expression (1), and performing the binarization processing for the time-series pattern of the continuous value obtained after the projection so as to set each positive value to “1” and each negative value to “−1”.
[Math. 1]
C=XAₖAₖ^{T} (1)
In the expression, C represents a behavior time-series pattern matrix after the projection, and is expressed by the following matrix.
$$C = ( \begin{matrix}{c}_{1} \\ {c}_{2} \\ ⋮ \\ {c}_{m}\end{matrix} )$$
Further, X represents a work behavior time-series pattern matrix, and is expressed by the following matrix.
$$X = ( \begin{matrix}{x}_{1} \\ {x}_{2} \\ ⋮ \\ {x}_{m}\end{matrix} )$$
$${X}_{i} = [ {x}_{i 1} , {x}_{i 2} , … , {x}_{in} ]$$
( . . . (n represents the number of dimensions) represents a daily work behavior time-series pattern)
Aₖ represents a principal component pattern matrix (k eigen-behavior time-series patterns aⱼ arrayed in descending order of the eigenvalue in column) as indicated below.
Aₖ=[a₁,a₂, . . . , aₖ]

5. A stress assessment device according to claim 3, wherein the presence/absence of the predetermined work behavior comprises presence/absence of a PC operation of each employee and presence/absence of a meeting in predetermined temporal units.

6. A stress assessment method, comprising:
(a) acquiring a work behavior time-series pattern serving as information indicating a work behavior of each employee in temporal units;
(b) calculating an eigen-behavior time-series pattern serving as information indicating standard work behaviors of a plurality of employees by using the work behavior time-series patterns; and
(c) calculating a degree to which the work behavior time-series pattern of each employee with respect to the eigen-behavior time-series pattern and the eigen-behavior time-series pattern agree with each other, setting the degree as reconstruction accuracy, and assessing a stress state of the employee based on the reconstruction accuracy.

7. A stress assessment method according to claim 6, wherein the (c) comprises assessing that the stress state is lower as the reconstruction accuracy becomes higher when it is defined that the reconstruction accuracy is higher as the work behavior time-series pattern of the employee agrees with the eigen-behavior time-series pattern to a higher degree.

8. A stress assessment method according to claim 7, wherein:
the work behavior time-series pattern comprises data obtained by performing binarization processing for presence/absence of a predetermined work behavior of each employee in temporal units to be arrayed in time series;
the eigen-behavior time-series pattern comprises data obtained by performing principal component analysis processing by using the accumulated work behavior time-series patterns as an input; and
the (c) comprises:
performing projection for each work behavior time-series pattern of the employee with respect to a space defined by a principal component pattern by using the following Expression (1);
obtaining a reconstruction time-series pattern by performing the binarization processing for a time-series pattern of a continuous value obtained after the projection so as to set each positive value to “1” and each negative value to “−1”;
comparing an agreement rate between the reconstruction time-series pattern and the work behavior time-series pattern, to thereby calculate the reconstruction accuracy; and
assessing the stress state based on the reconstruction accuracy.
[Math. 2]
C=XAₖAₖ^{T} (1)
In the expression, C represents a behavior time-series pattern matrix after the projection, and is expressed by the following matrix.
$$C = ( \begin{matrix}{c}_{1} \\ {c}_{2} \\ ⋮ \\ {c}_{m}\end{matrix} )$$
Further, X represents a work behavior time-series pattern matrix, and is expressed by the following matrix.
$$X = ( \begin{matrix}{x}_{1} \\ {x}_{2} \\ ⋮ \\ {x}_{m}\end{matrix} )$$
( . . . (n represents the number of dimensions) represents a daily work behavior time-series pattern)
Aₖ represents a principal component pattern matrix (k eigen-behavior time-series patterns aⱼ arrayed in descending order of the eigenvalue in column) as indicated below.
Aₖ=[a₁,a₂, . . . , aₖ]

9. A stress assessment method according to claim 8, wherein the presence/absence of the predetermined work behavior comprises presence/absence of a PC operation of each employee and presence/absence of a meeting in predetermined temporal units.

10. A recording medium comprising a program recorded thereon for causing a computer to operate as the stress assessment device according to claim 1.
